(19) United States
(12) Patent Application Publication
(10) Pub. No.: US 2026/0096949 A1
(43) Pub. Date: Apr. 9, 2026

(54) Filling and Finishing System for Cell/Gene Therapy Product

(71) Applicant: Biocut, LLC, Muskego, WI (US)

(72) Inventors: Jack Michael Leonovicz, Brookfield, WI (US); Thor Gustave Holmgren, Milwaukee, WI (US); Joshua Michael Jendusa, Waterford, WI (US)

(21) Appl. No.: 18/905,421

(22) Filed: Oct. 3, 2024

Related U.S. Application Data
(63) Continuation of application No. PCT/US2024/041104, filed on Aug. 6, 2024.
(60) Provisional application No. 63/518,009, filed on Aug. 7, 2023.

(51) Int. Cl. A61J 1/05

(52) U.S. Cl. CPC A61J 1/05

(57) ABSTRACT

A modular filling and finishing system for cell/gene therapy is provided. One or more filling and finishing modules are coupled together. In a specific embodiment, the filling and finishing system includes a base module. In various embodiments, the filling and finishing system includes the base module and one or more expansion modules coupled to the base module. The filling and finishing system is configured to be a compact system with a desired throughput.

### CROSS-REFERENCE TO RELATED PATENT APPLICATIONS

The present application is a continuation of International Application No. PCT/US2024/041104, filed Aug. 6, 2024, which claims the benefit of and priority to U.S. Provisional Application No. 63/518,009 filed on Aug. 7, 2023, each of which is incorporated herein by reference in its entirety.

### BACKGROUND OF THE INVENTION

The present invention relates generally to a Final Drug Product (FDP) filling and finishing system for cell or gene therapy products. The present invention relates specifically to a filling and finishing system for filling containers with cell or gene therapy products (i.e., autologous cell therapies, allogenic cell therapies, viral vector products, etc.).

In general, once source material has been collected and processed or isolated for use in cell or gene therapies, the processed therapy products are distributed into containers (i.e., bags, vials, etc.) using filling and finishing systems before being shipped and administered to patients. Filling and finishing systems are typically sized for a particular use (i.e., benchtop system for a laboratory, large system for commercial production).

### SUMMARY OF THE INVENTION

One embodiment of the invention relates to a filling and finishing system for cell or gene therapy products. The filling and finishing system includes a base module and one or more expansion modules coupled to the base module. The base module includes a housing with a cooling plate coupled to the housing, an agitation system including an agitation bar coupled to the housing and a container slot. The container slot is configured to receive and hold a first container. The one or more expansion modules are coupled to the base module. Each one of the one or more expansion modules include a container slot configured to receive and hold a second container. The base module is configured to distribute a filling solution, such as a cell solution into at least one of the first container and the second container. The base module and the one or more expansion modules together define a dimension less than a maximum dimension. The base module and the one or more expansion modules have a filled container output greater than a minimum filled container output.

Another embodiment of the invention relates to a filling and finishing system for therapy products. The filling and finishing system includes a base module and an expansion module coupled to the base module. The base module includes a housing with a cooling plate coupled to the housing and a container slot. The base module further includes an agitation system including an agitation bar hingedly coupled to the housing. The agitation bar moves non-linearly. The container slot is configured to receive and hold a first container. The base module is configured to distribute a filling solution into at least one of the first container and the second container.

Another embodiment of the invention relates to a filling and finishing system for therapy products. The filling and finishing system includes a base module and at least one expansion module coupled to the base module. The base module includes a housing with a cooling plate coupled to the housing and a container slot. The base module further includes an agitation system including an agitation bar coupled to the housing. The agitation bar moves non-linearly. The container slot is configured to receive and hold a first container. The at least one expansion module is coupled to the base module. Each one of the at least one expansion modules include a container slot configured to receive and hold a second container. The base module is configured to distribute a filling solution into at least one of the first container and the second container. The base module and the at least one expansion modules together define a width less than a maximum width. The base module and the at least one expansion module have a filled container output greater than a minimum filled container output.

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a front view of a filling and finishing system with a base module, a bag module, and a vial module, according to an exemplary embodiment.

FIG. 2 is a perspective view of the base module of FIG. 1, according to an exemplary embodiment.

FIG. 3 is a perspective view of the base module of FIG. 1, according to an exemplary embodiment.

FIG. 4 is a front view of the bag module of FIG. 1, according to an exemplary embodiment.

FIG. 5 is a front view of the vial module of FIG. 1, according to an exemplary embodiment.

FIG. 6 is a front view of a filling and finishing system with a base module and a bag module, according to another exemplary embodiment.

FIG. 7 is a front view of a filling and finishing system with a base module and a vial module, according to another exemplary embodiment.

FIG. 8 is a detailed view of a cooling plate and agitation system of the base module of FIG. 1, according to an exemplary embodiment.

FIG. 9 is a cross-sectional view of the cooling plate and agitation system of the base module of FIG. 1, according to an exemplary embodiment.

FIG. 10 is a flow diagram of a method of using the filling and finishing system, according to an exemplary embodiment.

FIG. 11 is a flow diagram of a method of evacuating air from fill containers, according to an exemplary embodiment.

FIG. 12 is a base module of a filling and finishing system, according to another exemplary embodiment.

FIG. 13 is a diagram showing a sampling process of the filling and finishing system, according to an exemplary embodiment.

FIG. 14 is a diagram showing a formulation process of the filling and finishing system, according to an exemplary embodiment.

FIG. 15 is a diagram showing a fluid evacuation process into a source bag of the filling and finishing system, according to an exemplary embodiment.

FIG. 16 is a diagram showing an air evacuation process of the filling and finishing system, according to an exemplary embodiment.

FIG. 17 is a diagram showing a filling process of the filling and finishing system, according to an exemplary embodiment.

FIG. 18 is a flow diagram of a method of using the filling and finishing system, according to another exemplary embodiment.

### DETAILED DESCRIPTION

Referring generally to the figures, various embodiments of a Final Drug Product (FDP) filling and finishing device and/or system for cell/gene therapy products are shown. In various embodiments, the filling and finishing device and/or system can be used for viral vector aliquoting, media aliquoting, cell baking, gene therapy, cell therapy, and gene and cell products. Various embodiments of the filling and finishing device and/or system discussed herein are configured to be customizable in terms of both footprint (i.e., dimensions of the system) and throughput (i.e., number of containers filled over a period of time). Applicant has developed various modules discussed herein that can be coupled together to allow for the customization of the filling and finishing system by the user. In various embodiments, the filling and finishing system includes a base module that is usable with expansion modules that alter the capacity of the filling and finishing system. As will be generally understood, filling and finishing systems are typically designed and/or sized for use within a specific environment type (i.e., laboratory, pilot scale, full-scale commercial). The designs discussed herein relate to a filling and finishing system including modular components such that the system is customizable to produce a desired output. The customization allows for use of the filling and finishing system in a range of environments. Applicant believes the modularity and customizability of the filling and finishing system discussed herein allows for the use of a single filling and finishing system across a range of environments from a laboratory setting to a full-scale commercial production environment.

Additionally, Applicant has developed various improvements to the processing capability of the base module and/or expansion modules. In various embodiments, the cell suspension and cooling system maintains cell viability while ensuring homogeneity of the cell product solution with a compact base module and/or expansion module. Applicant has determined various relevant parameters to the suspension and cooling of a cell product, such as agitation speed, force, time, angle of agitation bar, cooling plate surface area, etc., can be selected to ensure the filling and finishing system distributes the cells and/or fluids in the cell product solution without hindering cell viability or requiring a bulky device or use of a freezer.

Further, Applicant believes use of monitoring devices, such as flow meters allows the filling and finishing system discussed herein to have a large throughput or capacity while maintaining filling accuracy. In contrast to conventional filling and finishing devices that may use a load cell or scale, the flow meters can be used to measure the amount of cell product solution in each of the filling containers such that filling can be stopped once a selected volume has been reached. Applicant believes use of flow meters improves accuracy and/or precision of the filling of the containers.

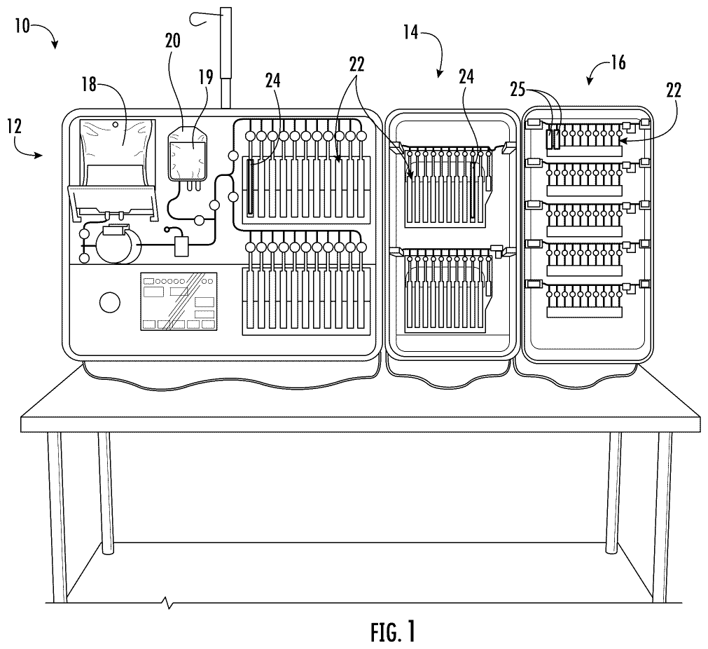

Referring to FIG. 1, various aspects of a filling and finishing device and/or system, shown as cell/gene therapy product filling and finishing system 10, are shown. As will generally be understood, once blood, tissues, or another cellular source has been collected and processed or isolated for use in cell therapies, the resultant therapy products need to be distributed into containers (i.e., bags, vials, etc.). The distribution of the cellular products requires mixing and cooling to ensure an even or homogenous distribution of the cell products into containers, while the viability or health of the cells must also be maintained. Filling and finishing systems like the system 10 discussed herein, perform the distribution and maintenance of the cell product before the filled containers are frozen and shipped for distribution and administration to patients.

Filling and finishing systems are typically sized for a particular use (i.e., benchtop system for a laboratory, large system for commercial production). In general, cell/gene therapy product filling and finishing system 10 includes a base module 12 and one or more expansion modules. Expansion modules are modules compatible with base module 12 that allow for user customization of both the size of system 10, the filling capacity, and the container type. FIG. 1 shows filling and finishing system 10 with base module 12 coupled to expansion modules shown as a bag module 14 and a vial module 16. In such an embodiment, bag module 14 is configured to hold and fill an additional number of containers and specifically bags 24, shown schematically, compared to the number of containers the base module 12 can fill alone. Similarly, vial module 16 is configured to hold and fill an additional number of containers and specifically vials 25, shown schematically. In various embodiments, the base module 12 holds and fills more than one type of container (i.e., bags, vials, etc.). In various specific embodiments, the expansion modules 14, 16 hold and fill more than one type of container (i.e., bags, vials, etc.). In other embodiments, the bag module 14 is designed to hold and fill bags 24 and the vial module is designed to hold and fill vials 25.

Base module 12 includes a source container, shown as source bag 18 that is filled with the previously processed cell product. A formulation container, shown as formulation bag 20 is also connected to base module 12. Formulation bag 20 includes a liquid 19 that can be mixed with the cell product within source bag 18 to create a consistent concentration of cells. In a specific embodiment, liquid 19 is a cryoprotectant such as Dimethylsulfoxide (“DMSO”). As will be generally understood, DMSO can help ensure cell viability by preventing ice formation during the cooling and freezing process. As will be discussed in greater detail below, the liquid 19 from formulation bag 20 can be added to source bag 18 to create a homogenous filling solution, such as a cell solution. After the homogenous cell solution is created, the containers 24, 25 can be filled.

Base module 12 includes a plurality of container slots or openings 22. Container slots 22 are sized to accommodate various sizes of containers. In various specific embodiments, container slots 22 are sized or dimensioned to hold bags 24 with bag fills from 1 mL to 100 mL. In various specific embodiments, container slots 22 are sized to hold vials 25 with vial fills from 1 mL to 5 mL.

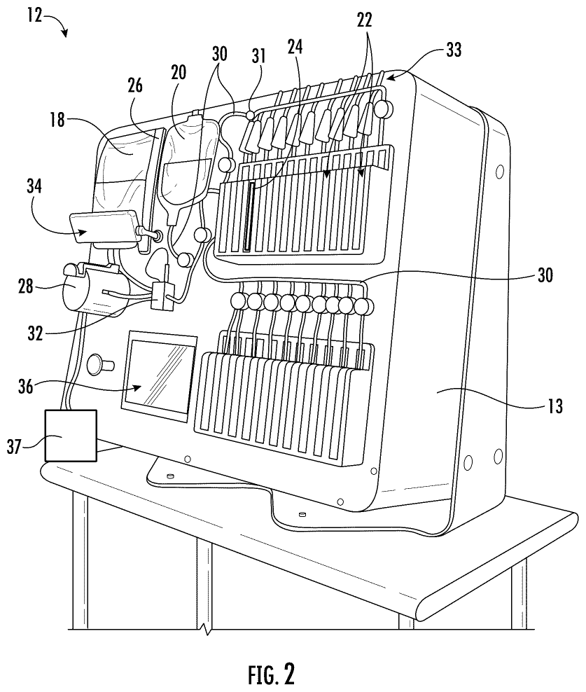

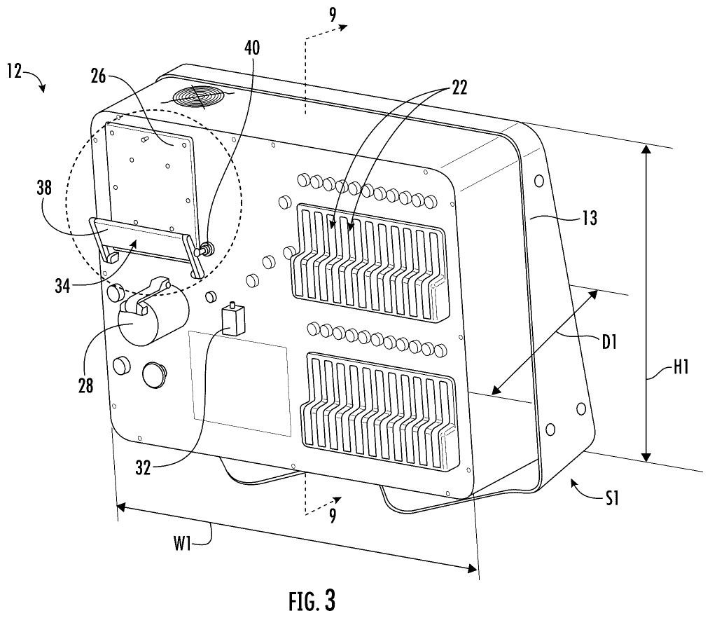

Referring to FIGS. 2-3, various details of base module 12 are shown according to an exemplary embodiment. Base module 12 includes a housing 13 with a cooling plate 26 coupled to a portion of the housing. In various embodiments, cooling plate 26 is formed from a metal material. In a specific embodiment, cooling plate 26 is formed from aluminum. Base module 12 includes an agitation system 34 that works with cooling plate 26 to mix the liquid 19 and the cell product within source bag 18. Agitation system 34 includes a moveable bar or plate, shown as agitation bar 38 and a drive mechanism shown as a drive lever 40 that moves agitation bar 38 relative to cooling plate 26 and/or housing 13 of base module 12.

Base module 12 further includes a pump shown as peristaltic pump 28 and a monitoring component, shown as flow meter 32. In a specific embodiment, flow meter 32 is an ultrasonic flow meter. A plurality of connectors 31, and passageways, shown as tubes 30 extend between and connect peristaltic pump 28, flow meter 32, source bag 18, formulation bag 20 and any containers 24, 25 positioned for filling within container slots 22.

As will be generally understood, the fluid distribution system of filling and finishing system is a manifold. The manifold 33 for filling and finishing system 10 is customizable based on the desired containers 24, 25 and required system functionality. The plurality of connectors 31, valves and tubes 30 together define a manifold 33. Base module 12 includes a display screen 36 that can be used to access a user interface (UI) and various electrical components (i.e., wires, printed circuit boards, power source) for connecting and powering the systems of base module 12. In a specific embodiment, a vent or auxiliary bag 37, shown schematically is coupled to base module 12 by tubes 30 and/or connectors 31. As will be described in greater detail below, the vent or auxiliary bag 37 allows for evacuation of air from the base module 12 and/or manifold 33.

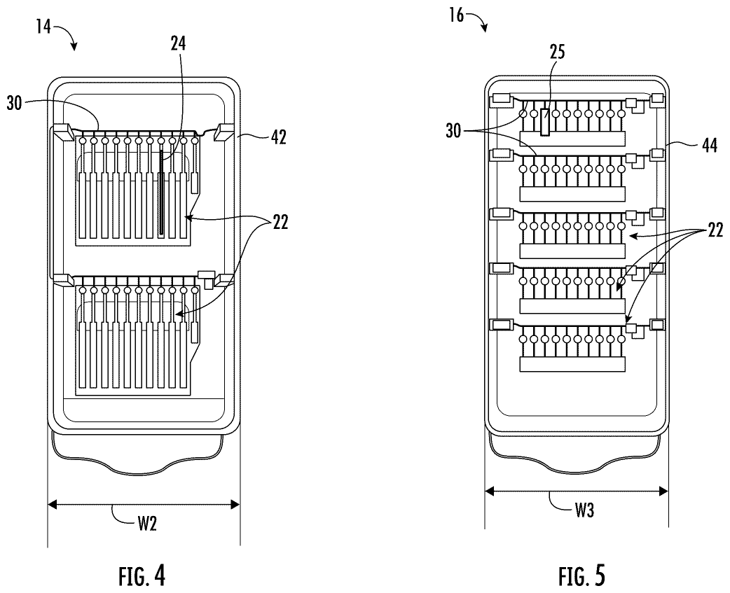

Referring to FIG. 4, a front view of bag module 14 is shown according to an exemplary embodiment. Bag module 14 includes a housing 42 with a plurality of container slots 22, connectors 31, and tubes 30 positioned to allow for filling of containers 24 positioned within container slots 22. When bag module 14 is used as part of filling and finishing system 10, bag module 14 is coupled to base module 12 to allow for distribution of the homogenous cell product from the base module 12 into the containers 24 and/or vials 25 of bag module 14.

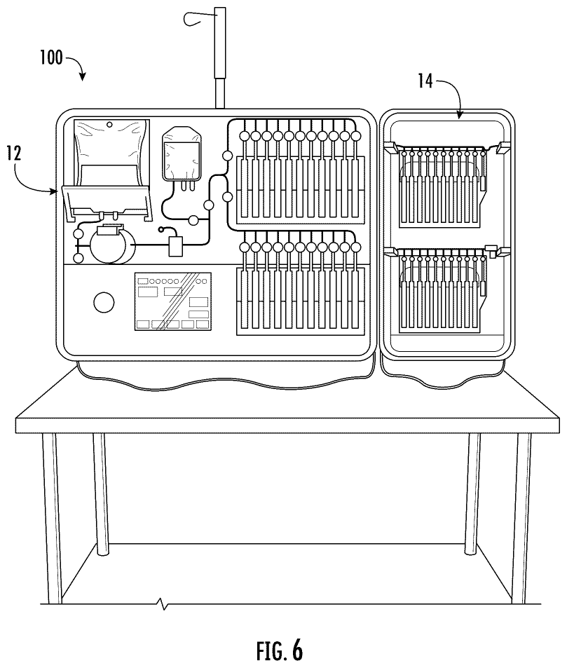

Referring to FIG. 5, a front view of vial module 16 is shown according to an exemplary embodiment. Vial module 16 includes a housing 44 with a plurality of container slots 22, connectors 31, and tubes 30 positioned to allow for filling of vials 25 positioned within container slots 22. When vial module 16 is used as part of filling and finishing system 10, vial module 16 is coupled to base module 12 to allow for distribution of the homogenous cell product from the base module 12 into the vials 25 of vial module 16.

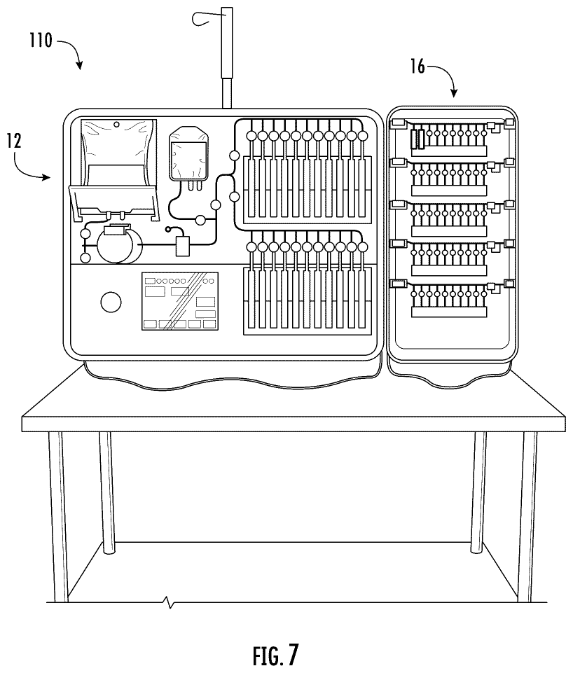

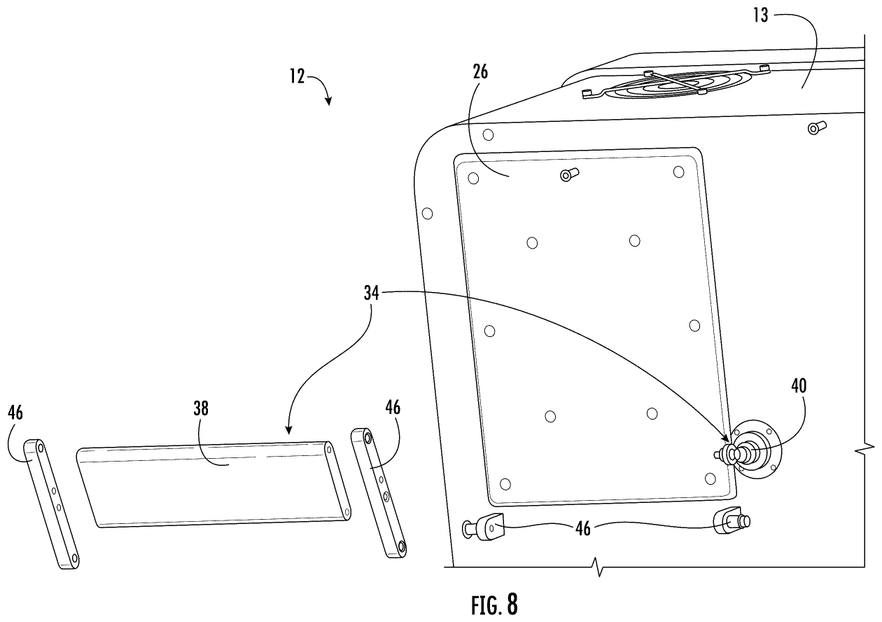

Referring to FIGS. 6-7, various filling and finishing systems are shown according to exemplary embodiments. FIG. 6 shows cell/gene therapy product filling and finishing system 100 which is the same as filling and finishing system 10 except for the differences discussed herein. Filling and finishing system 100 includes a base module 12 coupled and a bag module 14.

FIG. 7 shows cell/gene therapy product filling and finishing system 110 which is the same as filling and finishing systems 10 and 100 except for the differences discussed herein. Filling and finishing system 110 includes a base module 12 coupled and a vial module 16. In various other embodiments a filling and finishing system can include a different number of expansion modules 14, 16 (e.g., 3, 4, 5, etc.).

As previously noted, Applicant believes the modular design of filling and finishing system 10 allows for customization such filling and finishing system 10 can be sized for use within multiple environments (i.e., laboratory, pilot scale, full-scale commercial). For example, base module 12 can be used alone on a benchtop in a laboratory. In a specific embodiment, base module 12 has size S1 including a width, W1 of about 40 inches, a height H1 of about 33 inches and a depth, D1 of about 20 inches. In a specific embodiment, bag module 14 includes a width, W2 of about 18 inches. In a specific embodiment, vial module 16 includes a width, W3 of about 18 inches. In various specific embodiments, the width of the bag module 14 is the same as the width of the vial module 16.

In a specific embodiment, the base module 12 and the one or more expansion modules 14, 16 together define a dimension less than a maximum dimension with a filling capacity greater than a minimum filling capacity. In various specific embodiments, base module 12 provides filling for up to 20 containers 24, 25. In other words, in such embodiments, base module 12 can fill anywhere from 1 to 20 containers 24, 25. In various specific embodiments base module 12 and one or more expansion modules 14, 16 provide filling for up to 100 containers 24, 25. In other words, in such embodiments, base module 12 and one or more expansion modules 14, 16 can fill anywhere from 1 to 100 containers 24, 25.

In various other embodiments, base module 12 may be dimensioned to have a different volume. In a specific embodiment, when base module 12 has a size S1, the output is about 60 containers 24, 25 per hour at a 100 mL fill volume. As will generally be understood, the output is a function of final fill volume (i.e., amount of the therapy solution distributed to each container) and system configuration (i.e., flow rate, etc.). As such, in specific embodiments, when base module has size S1, the output is greater than about 60 containers 24, 25 per hour at fill volumes less than 100 mL. In a specific embodiment, when filling and finishing system 10 includes base module 12, bag module 14, and vial module 16, filling and finishing system 10 is sized or has a size including a width of about 76 inches, a height of about 33 inches, and a depth of about 20 inches and the output is about 180 containers 24, 25 per hour (e.g., 180 containers plus or minus 10 containers) at a 100 mL fill volume.

In various specific embodiments, the maximum dimension or maximum width of filling and finishing system 10 is less than 85 inches, specifically less than 80 inches, and more specifically less than 78 inches. In various specific embodiments, the minimum filled container output is about 170 containers (e.g., 170 containers plus or minus 10 containers) per hour at a 100 mL fill volume. In various specific embodiments, the minimum filled container output is about 175 containers (e.g., 175 containers plus or minus 10 containers) per hour at a 100 mL fill volume. In various specific embodiments, the maximum dimension or maximum width of filling and finishing system 10 is less than 70 inches, specifically less than 65 inches, and more specifically less than 60 inches. In various specific embodiments, the minimum filled container output is about 110 containers (e.g., 110 containers plus or minus 10 containers) per hour at a 100 mL fill volume. In various specific embodiments, the minimum filled container output is about 115 containers per hour at a 100 mL fill volume.

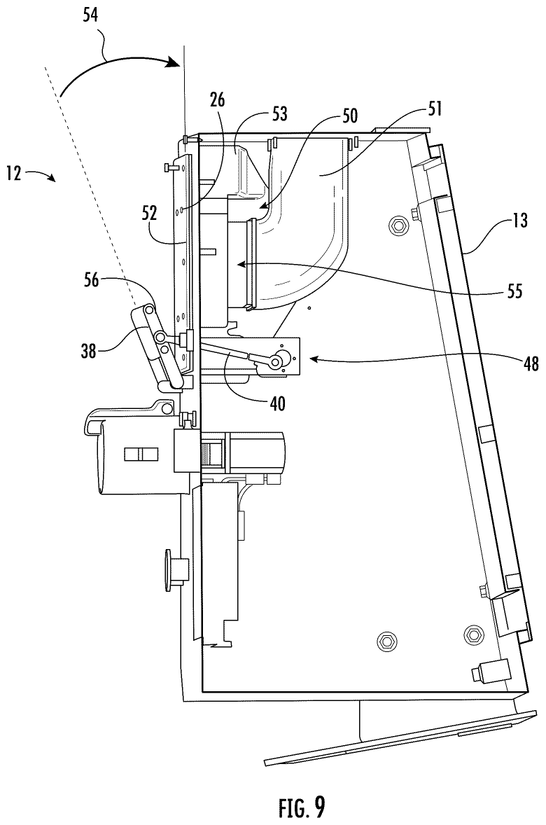

Referring to FIGS. 8-9, details of cooling plate 26 and agitation system 34 are shown, according to an exemplary embodiment. Agitation system 34 further includes pivot arms 46 coupled to opposing sides of agitation bar 38. Pivot arms 46 are coupled to projections 47 that extend outward, away from housing 13. Drive lever 40 is coupled to a pivot arm 46 and movement of drive lever 40 moves pivot arm 46 and therefore agitation bar 38 relative to housing 13 and specifically cooling plate 26.

As shown in FIG. 9, agitation bar 38 is positioned at an angle relative to housing 13. An inward facing (i.e., toward housing 13) surface 56 of agitation bar 38 and an outer surface 52 of cooling plate 26 define the position of agitation bar 38 when the agitation system 34 is not moving. Agitation bar 38 is positioned at an angle 54. When agitation system 34 is active, agitation bar 38 moves such that the angle is different than angle 54. In contrast to conventional paddles used during agitation, agitation bar 38 does not use a linear motion to squeeze source bag 18. In other words, agitation bar 38 moves with non-linear motion. Applicant believes using a particular approach angle that maximizes the approach angle will maximize the vertical component on the fluid within the source bag 18 and therefore the vertical movement or travel of the fluid improving the effective agitation.

The approach angle is chosen based on a starting or initial volume of source bag 18 after formulation because the volume within source bag 18 changes throughout the filling process. In various specific embodiments, when the volume of source bag 18 is 500 mL or less, the approach angle is from 2 degrees to 27 degrees. In various specific embodiments, when the volume of source bag 18 is 3000 mL, the approach angle is from 10 degrees to 35 degrees. The chosen approach angle can also be varied depending on the cell type and/or contents within the source bag 18 that are desired to be homogenized.

Agitation system 34 includes various agitation components 48 to allow for movement (e.g., crankshaft, motor, etc.). base module 12 further includes a cooling assembly 50 including various cooling components (e.g., inlet duct 51, outlet duct 53, cooler assembly 55, etc.). In a specific embodiment, inlet duct 51 provides a path for air, such as cool air, from the exterior into the interior of base module 12 while outlet duct 53 provides a path for warm air out of the interior of base module 12. In such an embodiment, cooler assembly 55 provides cooling to base module 12 and/or cooling plate 26. In various specific embodiments, a Peltier cooler device is used. In various specific embodiments, source bag 18 is cooled to a cooling range between 2 to 8 degrees Celsius. In order to maintain cell health, it is important that cells are within the cooling range prior to introducing the DMSO into the main source bag 18. Using the UI, the desired amount of cooling time prior to formulating can be programed to ensure the correct temperature range before introducing the DMSO.

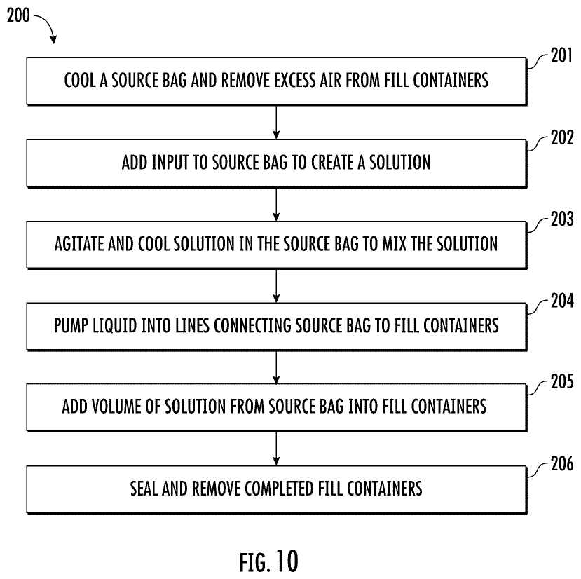

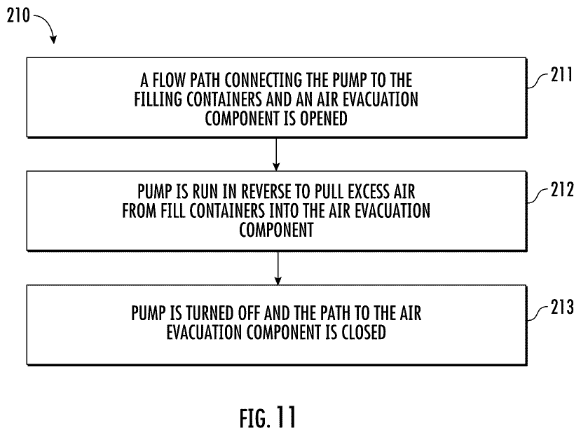

FIG. 10 provides a flow diagram of a method 200 for using filling and finishing system 10 according to the present disclosure. In a first step 201 of the method 200, the source bag 18 is positioned against cooling plate 26 to begin cooling and peristaltic pump 28 is used to remove excess air from the filling containers 24, 25. In a second step 202 of method 200, a desired volume of a secondary input such as liquid 19 is pumped from the formulation bag 20 into the source bag 18 to create a solution.

In a third step 203 of method 200, the agitation bar 38 moves and engages at least a portion of source bag 18 to mix the solution made up of the liquid 19 and the cellular product within source bag 18. The mixing must be gentle enough to maintain viability (i.e., avoid damage) to the cell product and also aggressive enough to push the cells from the bottom of source bag 18 to the top of source bag 18 in order to create a homogenous solution. During the third step 203 at least a portion of source bag 18 is in contact with outer surface 52 of cooling plate 26 to maintain the cells in a temperature range of about 0 to 8 degrees Celsius to ensure cell viability.

In a fourth step 204 of method 200, peristaltic pump 28 fills tubes 30 that extend between source bag 18 and containers 24, 25 with fluid to ensure there is no excess air within the connectors. As will be generally understood, excess air within the tubes 30 could impact the accuracy of the volume of fluid distributed into the containers 24, 25. In a fifth step 205, a desired fill volume for the containers 24, 25 which can be chosen by a user is distributed into the containers 24, 25. The flow meter 32 monitors the amount of solution moving to each container 24, 25 such that once the selected volume has been reached the base module will stop filling the containers 24, 25. In a sixth step 206, the filled containers 24, 25 can be sealed and removed from base module 12 and/or expansion modules 14, 16. Following the filling procedure, manual control settings can be used to push air from the evacuation bag and clear the tubes 30 with the final product into a chosen container. Filling and finishing system 10 further allows the final product to flow back into the source bag 18 when product recovery is desired.

Referring to FIG. 11, a flow diagram of a method 210 of evacuating the air from filling and finishing system 10 is shown according to an exemplary embodiment. In contrast to many conventional filling and finishing systems where the cell product is pumped out of the source bag and then moved back into the source bag, in method 210 the air is removed from the system without interacting with the filling or cell solution. Applicant believes the minimization of the movement of the cells using the pump reduces the risk of hindering cell viability and functionality of the cell solution and increases the efficiency of the filling process. Before beginning method 210, a user can optionally adjust evacuation time based on the type of container 24, 25 and the size or volume of the container that is being evacuated.

In a first step 211 of method 210, peristaltic pump 28 is connected to the filling containers 24, 25 through tubes 30 and a flow path connected to an air evacuation component such as a vent 37 to the exterior of base module 12 (i.e., outside air, atmosphere) or auxiliary bag 37 is opened. In other words, a flow path to source bag 18 is closed and another flow path to the vent or auxiliary bag 37 is opened. In a second step 212, the peristaltic pump 28 is turned on and run in reverse to remove excess air from the system. Specifically, air is pulled from containers 24, 25 and either out a vent or into the atmosphere or into an auxiliary bag 37. In various specific embodiments, five containers 24, 25 can be evacuated simultaneously. As will be generally understood, evacuating air additionally serves to clear any formulation media remaining in tubes 30.

In a third step 213, the peristaltic pump 28 is turned off, the flow path to the vent or auxiliary bag 27 is closed, and the flow path to source bag 18 is opened such that the base module 12 is prepared for the filling and finishing process. Once the excess air has been removed, the source bag 18 can be cooled and the filling and finishing process can proceed as described in FIG. 10.

Following the fill process, an additional air evacuation can be performed. In various embodiments, the air removal after the fill process is semi automated. Through the UI the flow rate is adjustable and individual containers can individually burp or remove air from a container 24, 25. In various embodiments, air can be removed from multiple containers 24, 25 simultaneously.

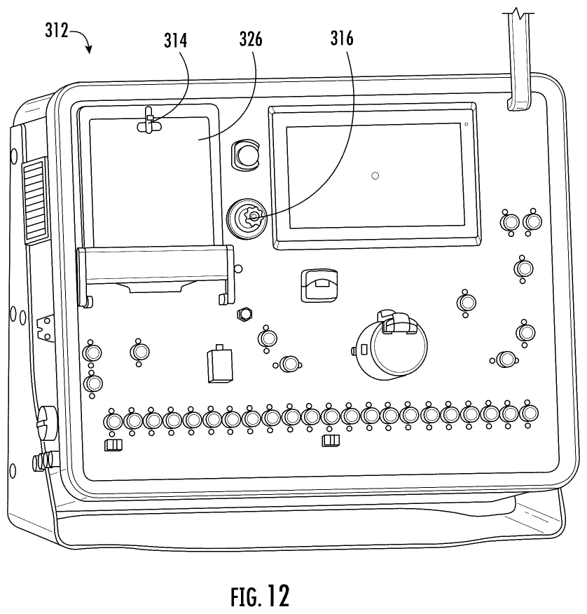

Referring to FIG. 12, a perspective view of a base module 312 is shown according to another exemplary embodiment. Base module 312 can be utilized with filling and finishing system 10. Base module 312 is substantially the same as base module 12 except for the differences discussed herein. Base module 312 includes a hook shown as adjustable hook 314 positioned along an edge of cooling plate 326. In a specific embodiment, adjustable hook 314 is positioned along a top or uppermost edge of cooling plate 326. Adjustable hook 314 allows for various source bag 18 sizes. In various specific embodiments, adjustable hook 314 allows for source bag 18 sizes from 250 mL to 3000 mL.

Base module 312 further includes knob, shown as mechanical knob 316. Mechanical knob 316 allows a user to adjust the stroke during the agitation process. As such, a user can manually adjust the agitation stroke as necessary for various source bag 18 sizes and/or fill volumes. In various embodiments, mechanical knob 316 allows for the adjustment of the resting or home position of the agitation bar 38.

Referring to FIG. 9, agitation bar 38 of base module 12, 312 is positioned at a first angle relative to a front surface of the housing 13 when in a resting position. Agitation bar 38 is positioned at a second angle relative to the front surface of the housing 13 when in an agitating position. In various specific embodiments, the second angle is less than the first angle. In various specific embodiments, the first angle is less than 70 degrees, specifically less than 60 degrees, and more specifically, less than 50 degrees.

As previously noted, the position of agitation bar 38 is adjustable. For example, when agitation bar 38 is at a first, or inward most position relative to housing 13, angle 54 has a minimum and maximum. In various specific embodiments, at the inward most position, agitation bar 38 has a minimum of 2 degrees and a maximum of 27 degrees. In other words, agitation bar 38 has a range of motion of 25 degrees. When agitation bar 38 is in a second, or outward most position relative to housing 13, angle 54 has a minimum and maximum that are different than the minimum and maximum at the inward most position. In various specific embodiments, at the outward most position, agitation bar 38 has a minimum of 18 degrees and a maximum of 43 degrees. In other words, agitation bar 38 still has a range of motion of 25 degrees.

Accordingly, for all of the adjustable positions, angle 54 has a minimum angle relative to housing 13 from 2 degrees to 18 degrees. Similarly, for all the adjustable positions, angle 54 has a maximum from 27 degrees to 43 degrees.

The filling and finishing system of claim 11, wherein the first angle is less than 60 degrees. The filling and finishing system of claim 11, wherein the a

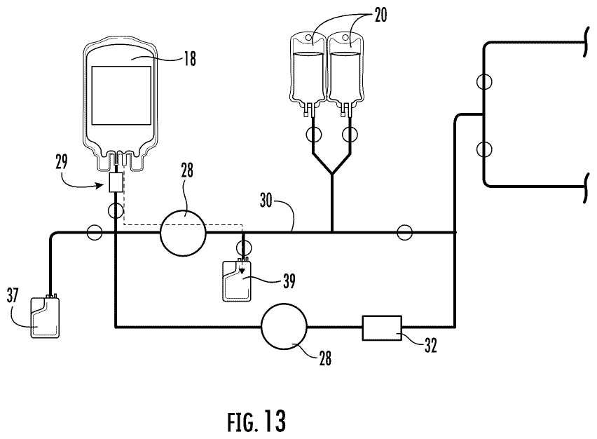

Referring to FIGS. 13-18, various processes of a filling and finishing system, such as filling and finishing system 10, are shown according to exemplary embodiments. The flow path through lines, such as tubes 30 are represented by the dotted lines. A bubble sensor 29 is connected to source bag 18 and a first and second pump 28 and flow meter 32 as previously discussed are shown schematically.

Referring to FIG. 13, a diagram showing a sampling process for a filling a finishing system, such as filling and finishing system 10, is shown according to an exemplary embodiment. Once source bag 18 has been agitated to form a homogenous mixture, source bag 18 can be sampled. As shown by the dotted line, there is a flow path between source bag 18 and a sample bag 39. Once a sample from source bag 18 is within sample bag 39 the flow process is paused. Next a count of sells in the sample bag 39 is performed. A user can then enter the cell count in the filling and finishing system and calculate the formulation volume.

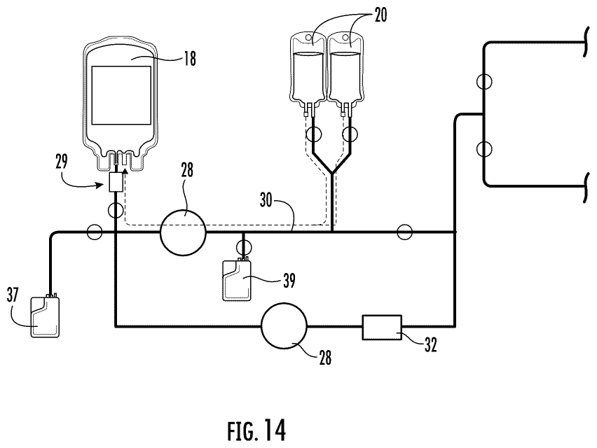

Referring to FIG. 14, a diagram showing a formulation process for a filling a finishing system, such as filling and finishing system 10, is shown according to an exemplary embodiment. As shown by the dotted line, there is a flow path between two formulation bags 20 and source bag 18. The fluid from the formulation bags 20 can be moved or pumped via pump 28 through tubes 30 into source bag 18 during the formulation process. In various specific embodiments, two formulation bags 20 are placed on a hanging pole coupled to the base module 12, 312.

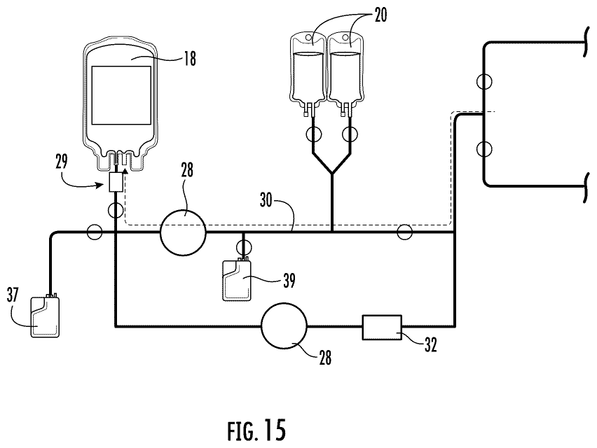

Referring to FIG. 15, a diagram showing the fluid evacuation or line clearing into source bag 18 is shown according to an exemplary embodiment. After the formulation process, air is removed from containers 24, 25. When removing the air, any fluid or residual material within the tubes 30 is cleared or moved into source bag 18 to ensure the filled containers 24, 25 are not altered by any residual material left in the tubes 30.

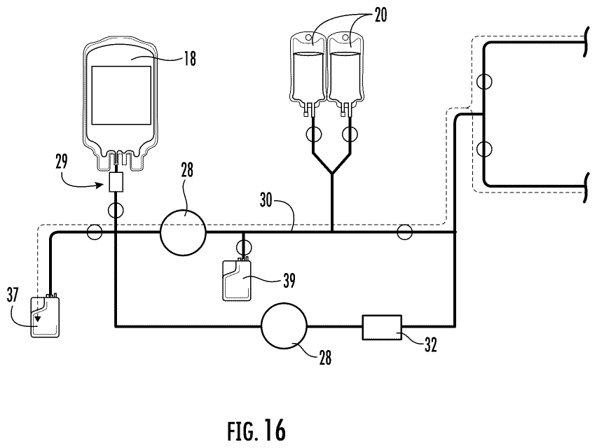

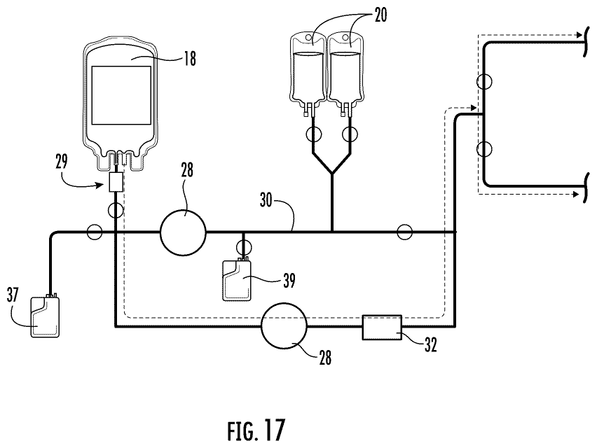

Referring to FIG. 16, a diagram showing the air evacuation process from final containers 24, 25 for a filling and finishing system, such as filling and finishing system 10 is shown according to an exemplary embodiment. As previously discussed, some of the evacuated air is used to clear tubes 30. The remainder of the air is removed as shown in FIG. 16 so as not to fill source bag 18 with excess air that may hinder the efficacy of agitation throughout the remainder of the filling process. As was discussed in greater detail above regarding method 210, air is evacuated from the system and into auxiliary bag 37. Referring to FIG. 17, a diagram showing the filling process for a filling and finishing system, such as filling and finishing system 10 is shown according to an exemplary embodiment. As was discussed in greater detail above regarding method 200 and base module 12, the solution after a final agitation is pumped from the source bag 18 into chosen containers 24, 25.

Filling and finishing system 10 is 21 CFR part 11 compatible. In other words, filling and finishing system 10 is equipped with all features required to implement and validate the process (e.g.., software, digital batch record generation, batch keeping, audit trail, etc.). Filling and finishing system 10 includes an all encompassing datalog such that a user can retrieve information for generating their own customer batch records.

In one or more embodiments, filling and finishing system 10 includes a QR scanner configured to be utilized with the single use manifold. Scanning the single use manifold provides a link to the batch record. In various specific embodiments, the finishing and filling system 10 is programmed with a GS1 encoding sequence to allow information from the label (e.g., part number, lot number, configuration specification) to be automatically input into the batch record. Additionally, scanning such information allows the filling and finishing system 10 to prevent a user from a running a procedure that is not compatible with the specific manifold being loaded onto the machine.

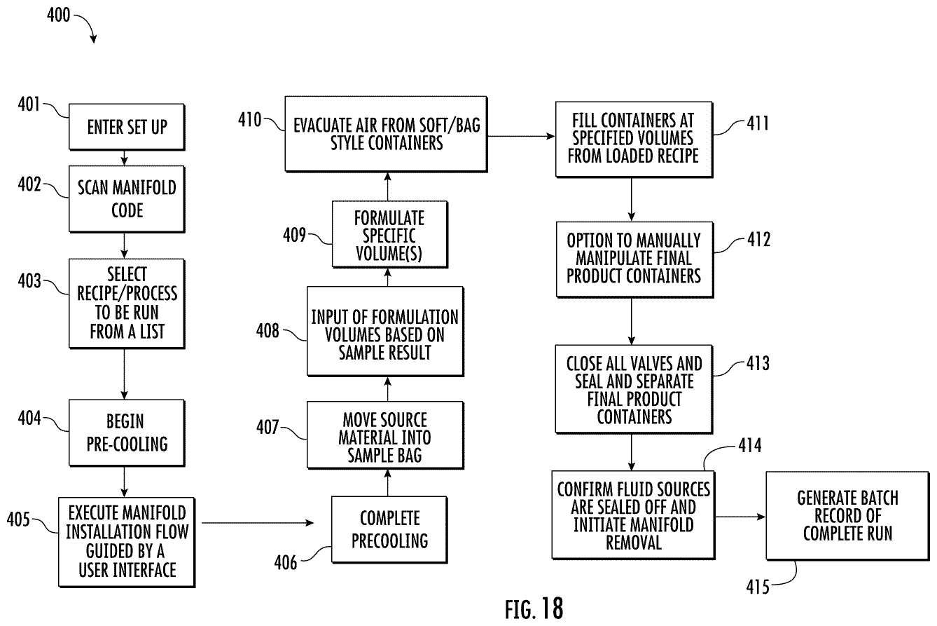

Referring to FIG. 18, a flow diagram showing of a method 400 for using filling and finishing system 10 according to another exemplary embodiment. In a first step 401 of method 400, a user can begin set up of filling and finishing system 10 such as by using display screen 36. In a second step 401, the manifold can be scanned. In various specific embodiments, the manifold includes a GS1 QR code and is scanned using the QR Scanner. In a third step 403, a user can select a specific recipe or process to be run. Filling and finishing system 10 provides a list of compatible recipes or processes based on the scan of the manifold. In a fourth step 404, the pre-cooling process is initiated. In a fifth step 405, the manifold is installed on filling and finishing system 10 following a guide provided by a user interface. In a sixth step 406, the pre-cooling process is completed.

In a seventh step 407, the source material is moved into sample bag 39. As previously discussed once the cell count is established the formulation volume is calculated. In a eighth step 408, the user inputs formulation volumes based on the sample result. In a ninth step 409, filling and finishing system 10 formulates the chosen volume(s). In a tenth step 410, air is evacuated from the filling and finishing system. In various specific embodiments, the air evacuation is performed according to method 210. In an eleventh step 411, containers 24, 25 are filled at specified volumes based on the recipe. In an optional twelfth step 412, a user can manually manipulate the filled containers 24, 25. In various embodiments, the user may manually remove any additional air if necessary.

In a thirteenth step 413, all of the valves in the filling and finishing system 10 are closed and the user can seal and separate the filled containers 24, 25. In a fourteenth step 414, the user confirms all fluid sources are seal and removes the manifold from the filling and finishing system 10. In a fifteenth step 415, filling and finishing system 10 generates a batch record of the entire run.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed:

1. A filling and finishing system for cell or gene therapy products, comprising:
a base module comprising:
a housing;
a cooling plate coupled to the housing;
an agitation system comprising an agitation bar coupled to the housing; and
a container slot, the container slot configured to receive and hold a first container;
one or more expansion modules coupled to the base module, each of the one or more expansion modules comprising:
a container slot configured to receive and hold a second container;
wherein the base module is configured to distribute a cell solution into at least one of the first container and the second container;
wherein the base module and the one or more expansion modules together define a dimension less than a maximum dimension; and
wherein the base module and the one or more expansion modules have a filled container output greater than a minimum filled container output.

2. The filling and finishing system of claim 1, wherein the maximum dimension is a maximum width, and wherein the maximum width is less than 80 inches.

3. The filling and finishing system of claim 2, wherein the minimum filled container output is 170 containers per hour.

4. The filling and finishing system of claim 1, wherein the maximum dimension is a maximum width, and wherein the maximum width is less than 65 inches.

5. The filling and finishing system of claim 4, wherein minimum filled container output is 110 containers per hour.

6. The filling and finishing system of claim 1, wherein the first container is a bag, wherein the bag is sized to contain a volume of 100 mL or less.

7. The filling and finishing system of claim 1, wherein the first container is a vial, wherein the vial is sized to contain a volume of 5 mL or less.

8. The filling and finishing system of claim 1, wherein the second container is one or a bag and a vial.

9. The filling and finishing system of claim 1, wherein the one or more expansion modules comprises a first expansion module and a second expansion module, and wherein the minimum filled container output is about 180 containers per hour.

10. A filling and finishing system for therapy products, comprising:
a base module comprising:
a housing;
a cooling plate coupled to the housing;
an agitation system comprising an agitation bar hingedly coupled to the housing, wherein the agitation bar moves non-linearly; and
a container slot, the container slot configured to receive and hold a first container;
an expansion module coupled to the base module, the expansion module comprising:
a container slot configured to receive and hold a second container;
wherein the base module is configured to distribute a filling solution into at least one of the first container and the second container.

11. The filling and finishing system of claim 10, wherein the agitation bar is positioned at a first angle relative to a front surface of the housing when in a resting position.

12. The filling and finishing system of claim 11, wherein the first angle is less than 60 degrees.

13. The filling and finishing system of claim 11, wherein the agitation bar is positioned at a second angle relative to the front surface of the housing when in an agitating position.

14. The filling and finishing system of claim 13, wherein the second angle is less than the first angle.

15. The filling and finishing system of claim 13, wherein the second angle is less than 45 degrees.

16. A filling and finishing system for therapy products, comprising:
a base module comprising:
a housing;
a cooling plate coupled to the housing;
an agitation system comprising an agitation bar coupled to the housing, wherein the agitation bar moves non-linearly; and
a container slot, the container slot configured to receive and hold a first container;
at least one expansion module coupled to the base module, each of the at least one expansion modules comprising:
a container slot configured to receive and hold a second container;
wherein the base module is configured to distribute a filling solution into at least one of the first container and the second container;
wherein the base module and the at least one expansion modules together define a width less than a maximum width; and
wherein the base module and the at least one expansion module have a filled container output greater than a minimum filled container output.

17. The filling and finishing system of claim 16, wherein the maximum width is less than 78 inches and wherein the minimum filled container output is 175 containers per hour.

18. The filling and finishing system of claim 16, the maximum width is less than 60 inches and wherein minimum filled container output is 115 containers per hour.

19. The filling and finishing system of claim 16, wherein the agitation bar is positioned at a first angle relative to a front surface of the cooling plate when in a resting position.

20. The filling and finishing system of claim 19, wherein the first angle is less than 45 degrees.
